(19) United States
(12) Patent Application Publication
(10) Pub. No.: US 2014/0370909 A1
(43) Pub. Date: Dec. 18, 2014

(54) REDUCED POWER LOCATION DETERMINATIONS FOR DETECTING GEO-FENCES

(71) Applicant: Microsoft Corporation, Redmond, WA (US)

(72) Inventors: Lanny D. Natucci, JR., Tacoma, WA (US); Janet L. Schneider, Bellevue, WA (US); Mark A. Inderhees, Woodinville, WA (US); Robert R. Dufalo, Milton, WA (US); Jonathan M. Kay, Redmond, WA (US); Cristina del Amo Casado, Seattle, WA (US); Sanjib Saha, Sammamish, WA (US); Fernando Gonzalez, Bellevue, WA (US); Priyanka B. Vegesna, Redmond, WA (US)

(21) Appl. No.: 13/918,776

(22) Filed: Jun. 14, 2013

(51) Int. Cl. H04W 52/02; H04W 4/02

(52) U.S. Cl. CPC H04W 52/0251; H04W 4/021; H04W 4/022
USPC 455/456.1; 455/574

(57) ABSTRACT

Various different areas of interest are identified, these areas being geographic areas that are also referred to as geo-fences. Whether a computing device is in a geo-fence can be determined based on the location of the geo-fence and the location of the computing device. The location of a computing device can be determined using various different location determination techniques, such as wireless networking triangulation, cellular positioning, Global Navigation Satellite System positioning, network address positioning, and so forth. Various power saving techniques are implemented to determine which techniques are used and when such techniques are used to reduce power consumption in the computing device.

### BACKGROUND

As computing technology has advanced, increasingly powerful mobile devices have become available. For example, smart phones have become commonplace. The mobility of such devices has resulted in different types of functionality being developed, such as location-based functionality in which certain actions are taken by the device based on the location of the device. While this functionality has many benefits, it is not without its problems. One such problem is that determining the location of the device typically consumes a lot of power. This can result in significant power usage in the device and reduced battery life, leading to user frustration and a poor user experience when using the device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a set of one or more geo-fences (e.g., places of interest) is selected. The selecting is based at least in part on desired accuracies to use in detecting geo-fence events (e.g., entering the geo-fence, exiting the geo-fence, staying in the geo-fence for a particular amount of time, etc.) for the set of one or more geo-fences and a distance from a computing device to at least one of the set of one or more geo-fences. Based on one or more power saving techniques, a determination is made of both which of multiple location determination modules to use to determine a location of the computing device and how often to have one or more of the multiple location determination modules determine the location of the computing device.

In accordance with one or more aspects, a computing device includes a data store, one or more location determination modules, and a power saving location checking module. The data store stores geo-fence data for multiple geo-fences. The one or more location determination modules are each configured to provide a location of the computing device. The power saving location checking module invokes, based at least in part on sizes of one or more of the multiple geo-fences and a closest one of the multiple geo-fences, one or more of the multiple location determination modules.

### BRIEF DESCRIPTION OF THE DRAWINGS

The same numbers are used throughout the drawings to reference like features.

FIG. 1 illustrates an example system in which the reduced power location determinations for detecting geo-fences discussed herein can be used.

FIG. 2 is a block diagram illustrating an example system implementing the reduced power location determinations for detecting geo-fences in accordance with one or more embodiments.

FIG. 3 illustrates an example user interface that can be displayed to a user to allow the user to select whether locations are to be determined in accordance with one or more embodiments.

FIG. 4 is a flowchart illustrating an example process for reduced power location determinations for detecting geo-fences in accordance with one or more embodiments.

FIG. 5 is illustrates an example implementation of determining a location of the device while leveraging one or more of various power saving techniques in accordance with one or more embodiments.

FIG. 6 illustrates an example process for identifying geo-fence tracking parameters in accordance with one or more embodiments.

FIG. 7 illustrates multiple overlapping geo-fences in accordance with one or more embodiments.

FIG. 8 illustrates an example system includes an example computing device that is representative of one or more systems and/or devices that may implement the various techniques described herein.

### DETAILED DESCRIPTION

Reduced power location determinations for detecting geo-fences are discussed herein. Whether a computing device is in a geo-fence can be determined based on the location of the geo-fence and the location of the computing device. Various different areas of interest to a computing device are identified, these areas being geographic areas also referred to as geo-fences. The location of the computing device can be determined using various different location determination techniques, such as wireless networking triangulation, cellular positioning, Global Navigation Satellite System positioning, network address positioning, and so forth. Various power saving techniques are implemented to determine which techniques are used and when such techniques are used to reduce power consumption in the computing device.

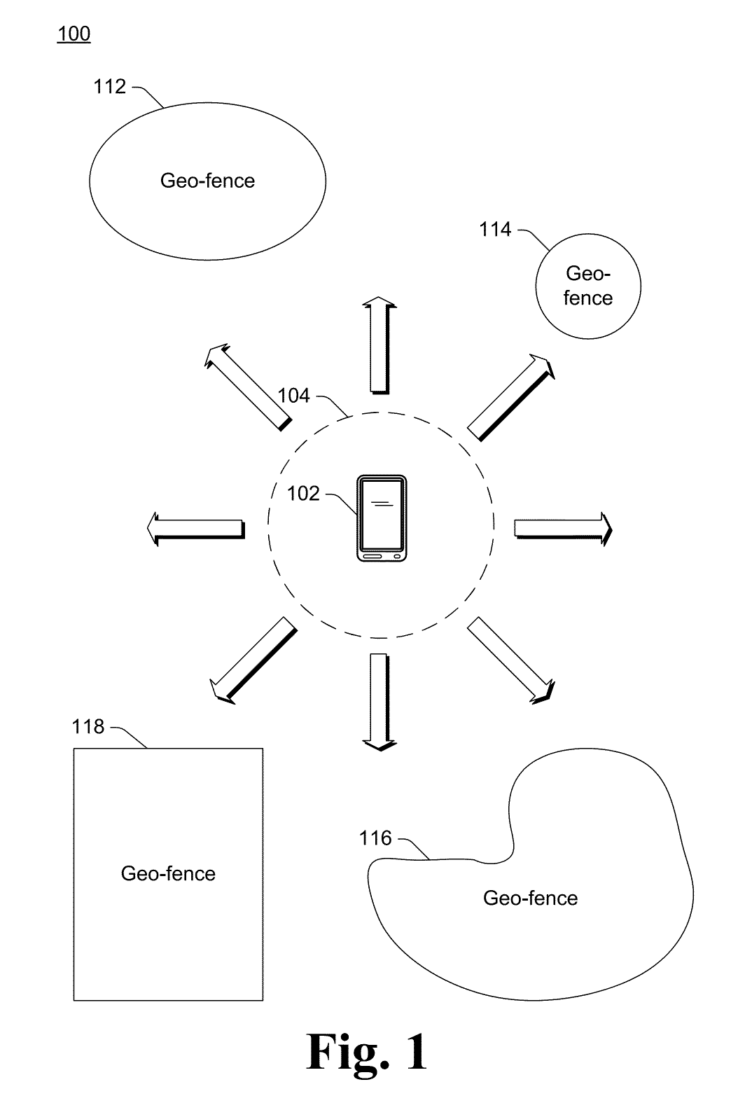

FIG. 1 illustrates an example system 100 in which the reduced power location determinations for detecting geo-fences discussed herein can be used. The system 100 includes a computing device 102, which can be any of a variety of types of devices, although typically is a mobile device. For example, the computing device 102 can be a smart phone or other wireless phone, a laptop or netbook computer, a tablet or notepad computer, a wearable computer, a mobile station, an entertainment appliance, an audio and/or video playback device, a game console, an automotive computer, and so forth. The computing device 102 is typically referred to as being a mobile device because the device 102 is designed or intended to be moved to multiple different locations (e.g., taken by a user with him or her as the user goes to different locations).

The location of the computing device 102 can be determined using any of a variety of different techniques, such as wireless networking (e.g., Wi-Fi) triangulation, cellular positioning, Global Navigation Satellite System (GNSS) positioning, network address (e.g., Internet Protocol (IP) address) positioning, and so forth as discussed in more detail below. Different location determination techniques can have different accuracy errors or associated uncertainties. For example, a location determination technique may be accurate to 10 meters (m) or 10 kilometers (km). The exact position of the computing device 102 is thus not pinpointed, but is illustrated as an area 104 surrounding the computing device 102. The area 104 represents the uncertainty in the determined location or position of the computing device 102, so although the computing device is determined to be at a particular location or position (e.g., approximately the center of the area 104), the computing device 102 may actually be anywhere within the area 104.

The system 100 also illustrates multiple geo-fences 112, 114, 116, and 118. Each geo-fence 112-118 can be any of a variety of different places of interest to the computing device 102, to the user of the computing device 102, to a program running on the computing device 102, and so forth. For example, a geo-fence 112-118 can be the user's home, the user's workplace, restaurants or businesses that may be visited by the user, educational facilities, public services (e.g., hospitals or libraries), geographic places (e.g., cities or states), and so forth.

The location of geo-fences 112-118 is maintained in or otherwise accessible to the computing device 102. It should be noted that different users of the computing device 102 can optionally have different geo-fences maintained or accessed. The computing device 102 is mobile and can enter and exit geo-fences 112-118. At any given time, the computing device 102 can be within one of geo-fences 112-118, or within no geo-fence. If the computing device 102 is determined to be within the area that encompasses a particular geo-fence, then the computing device 102 is referred to as being inside or within that particular geo-fence. However, if the computing device 102 is determined to not be within the area that encompasses a particular geo-fence, then the computing device 102 is referred to as being outside or not within that particular geo-fence. Situations can also arise in which two or more geo-fences overlap, in which case the computing device 102 can be within two or more geo-fences 112-118 at one time. It should be noted that the illustration of FIG. 1 is not to scale, and that geo-fences 112-118 can be, and typically are, significantly larger in size than the computing device 102.

In the illustrated example, the area 104 does not intersect any of the geo-fences 112-118, and thus the computing device 102 is outside each of the geo-fences 112-118. However, if the area 104 were to at least partially overlap one of the geo-fences 112-118, then the computing device 102 is possibly inside the geo-fence that is overlapped. Whether the computing device 102 is determined to be inside the geo-fence or outside the geo-fence in such situations can be determined in various manners, such as based on the presence of an overlap, how much of the geo-fences overlap, and so forth.

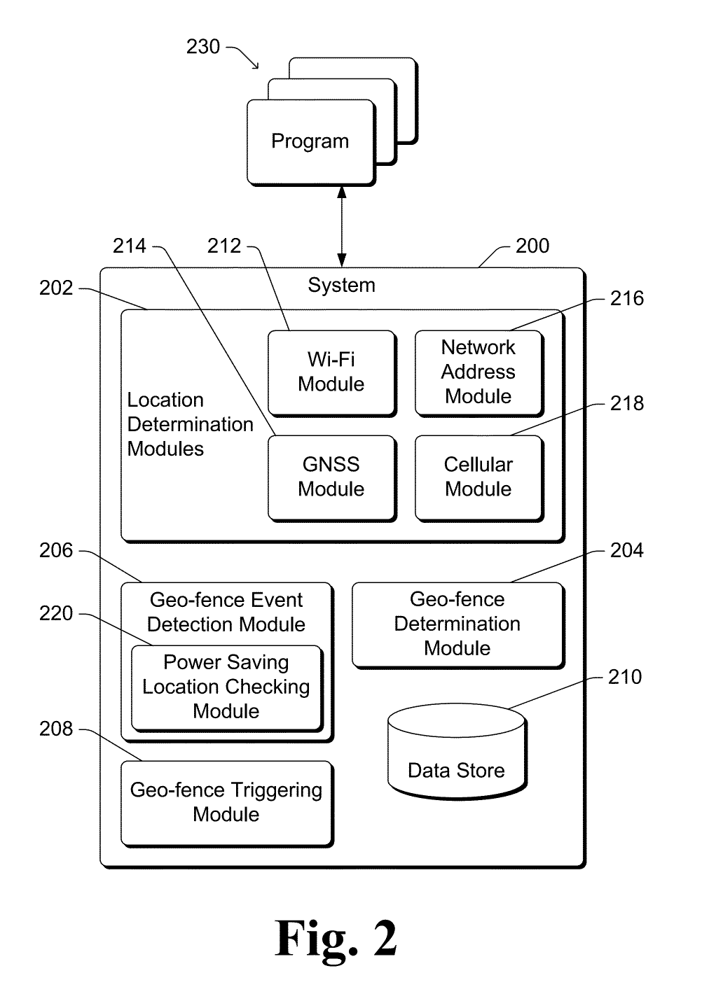

FIG. 2 is a block diagram illustrating an example system 200 implementing the reduced power location determinations for detecting geo-fences in accordance with one or more embodiments. The system 200 can be implemented by a single device such as the computing device 102 of FIG. 1, or alternatively multiple devices such as the computing device 102 and one or more server computers accessed via a network (e.g., a cellular or other wireless phone network, the Internet, etc.). The system 200 includes one or more location determination modules 202, a geo-fence determination module 204, a geo-fence event detection module 206, a geo-fence triggering module 208, and a data store 210.

The data store 210 maintains various data used by the techniques discussed herein. The data store 210 can be implemented using any of a variety of different storage devices, such as system memory (e.g., random access memory (RAM)), Flash memory or other solid state memory, magnetic disks, optical discs, and so forth. The data maintained in the data store 210 identifies multiple geo-fences, including geo-fence data for each of multiple geo-fences. Geo-fence data can be obtained from various sources, such as from a distributor or reseller of the data store 210 that stores the data on the data store 210, from a program running on a computing device implementing the system 200, from another device or service, and so forth. The geo-fence data for a geo-fence describes the boundary of the geo-fence, as well as the criteria to be satisfied in order for the geo-fence to be triggered.

The criteria to be satisfied can refer to a device entering the geo-fence, exiting the geo-fence, staying within the geo-fence for a particular amount of time (e.g., at least a threshold amount of time, no more than a threshold amount of time, etc.), a time period for the geo-fence (e.g., a start time and end time, a start time and a duration), combinations thereof, and so forth. One or more actions that are taken in response to the geo-fence being triggered (the criteria being satisfied) can also be included as part of the geo-fence data. Any of a variety of actions can be taken when a geo-fence is triggered, such as a particular program being notified, particular content being displayed or otherwise played back by the computing device, the geo-fence data being deleted from the data store 210, combinations thereof, and so forth. Multiple different actions can be taken based on the manner in which the geo-fence is triggered, such as one action taken in response to the device entering the geo-fence, and another action taken in response to the device exiting the geo-fence.

The boundary of the geo-fence can be specified in any of a variety of different manners. For example, the geo-fence can be specified as a position (e.g., latitude and longitude coordinates) and a radius, as a set of positions (e.g., latitude and longitude coordinates of corners of the geo-fence), as a series of vectors, and so forth. In the discussions herein, reference is made to the geo-fences being approximately circular in shape. However, it should be noted that the geo-fences can be any of a variety of regular geometric shapes (e.g., triangles, rectangles, octagons, and so forth), other geometric shapes (e.g., freeform shapes or blobs), and so forth.

The data store 210 is illustrated in FIG. 2 as being part of the system 200. It should be noted that the data maintained in the data store 210 can be obtained from the programs 230 (e.g., from the programs 230 as they are loaded in a computing device implementing the system 200). Alternatively, one or more of the programs 230 can include a data store that is used in addition to, or in place of, the data store 210.

The geo-fences can be used in a variety of different manners. For example, a geo-fence and action to be taken can be to alert a user of a computing device implementing at least part of the system 200 when they are approaching a bus stop, to give the user a coupon when they enter a shopping mall or store, to notify a parent when their child has left school or entered their home, to display weather information for a current location when the user travels to a different city, and so forth.

The location determination modules 202 include one or more modules that determine the location of the computing device 102. In the illustrated example, the location determination modules 202 include a Wi-Fi module 212, a GNSS module 214, a network address module 216, and a cellular module 218. It should be noted, however, that these modules 212-218 are examples and that the location determination modules 202 need not include each of the modules 212-218 and/or that the location determination modules 202 can include one or more additional modules that determine a location of the computing device 102 in different manners. For example, the location determination modules can include MEMS (Microelectromechanical systems), cameras, microphones, and so forth. Which of these location determination modules 202 is invoked, and when one or more of these location determination modules 202 is invoked, is determined based on various power saving techniques as discussed in more detail below.

It should be noted that the location determination modules 202 consume power, and that different amounts of power can be consumed by different ones of the location determination modules 202. If a location determination module A consumes more power than a location determination module B, the location determination module A is referred to as being the higher power location determination module and the location determination module B is referred to as being the lower power location determination module.

The Wi-Fi module 212 uses Wi-Fi signals, such as triangulation of Wi-Fi signals, to determine the location of the computing device 102. The Wi-Fi module 212 can receive signals from various wireless access points, including an identifier of a particular wireless access point and/or a particular wireless network from which a signal is received. For example, a wireless access point may send a media access control (MAC) address of the wireless access point, a basic service set identifier (BSSID) of a wireless network supported by the wireless access point, and so forth. The Wi-Fi module 212 can also measure a strength (e.g., received signal strength indicator (RSSI) values) of these received signals. It should be noted that the Wi-Fi module 212 can, at any given time for any given position of the computing device, receive signals from multiple wireless access points. The Wi-Fi module 212 can maintain or otherwise access a record of wireless access points, signal strengths, and corresponding locations to determine the location of the computing device at any particular time given the wireless access points from which signals are received and the strength of those signals at the particular given time. Alternatively, the Wi-Fi module 212 can provide an indication of the wireless access points from which signals are received and the strength of those signals at a particular given time to a remote service (e.g., accessed via any of a variety of different types of networks) that determines and returns to the Wi-Fi module 212 an indication of the location of the computing device at that particular given time.

The GNSS module 214 uses GNSS positioning to determine the location of the computing device 102, determining a location of the computing device based on a particular number of satellites (e.g., four or more satellites) from which the GNSS module 214 can receive signals or otherwise communicate. The GNSS module 214 can implement the GNSS functionality using a variety of different technologies, including but not limited to the Global Positioning System (GPS), the Global Navigation Satellite System (GLONASS), the BeiDou (or Compass) navigation system, the Galileo positioning system, combinations thereof, and so forth. The GNSS module 214 operates in any of a variety of public and/or proprietary manners to determine, given the one or more satellites from which the GNSS module 214 can receive signals or otherwise communicate at any particular given time, the location of the computing device at that particular given time.

The network address module 216 uses network address positioning to determine the location of the computing device 102. The network address used can be any of a variety of network addresses, such as the IP address of the computing device. The network address module 216 can maintain or otherwise access a record of IP addresses or address ranges and corresponding locations to determine the location of the computing device at any particular time given the IP address assigned to the computing device at the particular given time. Alternatively, the network address module 216 can provide an indication of the IP address of the computing device at a particular given time to a remote service (e.g., accessed via any of a variety of different types of networks) that determines and returns to the network address module 216 an indication of the location of the computing device at that particular given time.

The cellular module 218 uses cellular positioning to determine the location of the computing device 102. The cellular module 218 can receive signals from various cell transceivers, including an identifier of a particular cell transceiver (e.g., a cell tower or transceiver identifier) from which a signal is received. The cellular module 218 can also measure a strength of these received signals. It should be noted that the cellular module 218 can, at any given time for any given position of the computing device, receive signals from multiple cell transceivers. The cellular module 218 can maintain or otherwise access a record of cell transceivers, signal strengths, and corresponding locations to determine the location of the computing device at any particular time given the cell transceivers from which signals are received and the strength of those signals at the particular given time. Alternatively, the cellular module 218 can provide an indication of the transceivers from which signals are received and the strength of those signals at a particular given time to a remote service (e.g., accessed via any of a variety of different types of networks) that determines and returns to the cellular module 218 an indication of the location of the computing device at that particular given time. Additionally or alternatively, the cellular module 218 can monitor state changes at low power and provide notifications (e.g., to the geo-fence event detection module 206), allowing movement detections at low power without requiring continuous polling.

The locations determined by the location determination modules 202 are typically latitude and longitude coordinates, although the location can alternatively be specified in other manners. Each of the location determination modules 202 has an associated uncertainty in the location that it determines, also referred to as an accuracy error or estimated accuracy error of the location. The amount of this uncertainty can be determined in various manners, such as being reported by the location determination module itself, being pre-configured in or otherwise accessible to other modules of the system 200 (e.g., the geo-fence event detection module 206), and so forth. The uncertainty results in a position uncertainty area for the location determined by a location determination module, the position uncertainty area being an area within which the computing device 102 may actually be for the determined location. In one or more embodiments, the position uncertainty area is an approximately circular area with the location determined by the location determination module being approximately the center of the circular area, and the radius of the approximately circular area being an error radius determined as the uncertainty for the location determination module. Alternatively, the position uncertainty area can be described using various other regular or other geometric shapes. Thus, a position uncertainty area for a location determination module can be a spatial error distribution function. An approximation of the spatial error distribution function can be a flat distribution over an area, although various other approximations or descriptions of the spatial error distribution function can alternatively be used.

The geo-fence determination module 204 determines one or more of the geo-fences identified in the data store 210 for which a determination is to be made as to whether the geo-fence is triggered. Data for numerous different geo-fences can be maintained in the data store 210, and one or more of those geo-fences is selected by the geo-fence determination module 204. The geo-fence determination module 204 can make this determination in a variety of different manners, such as based on a current distance between the geo-fences and the computing device (e.g., the distance between a currently determined location of the computing device and a location on the edges (or alternatively other portions) of the geo-fences), based on sizes of (areas encompassed by) the geo-fences, based on the geo-fence tracking parameters as discussed in more detail below, and so forth. The one or more geo-fences that are determined by the module 204 are those deemed more likely to be entered or exited based on various criteria, such as the current location of the computing device, and those one or more geo-fences can be the focus of the module 204 until the criteria changes. However, it should be noted that the geo-fence determination module 204 can determine whether a geo-fence is triggered for any of the geo-fences in the data store 210.

The geo-fence event detection module 206 obtains a current location of the computing device at regular or irregular intervals, and detects whether a geo-fence event occurs. These intervals can be selected dynamically based on current conditions (e.g., approximate distance to a closest geo-fence, power budget for the computing device, an estimated speed of movement of the computing device, and so forth). The geo-fence event detection module 206 includes a power saving location checking module 220 that determines when to invoke (e.g., activate) one or more of the location determination modules 202 to obtain the location of the computing device. The power saving location checking module 220 takes into account various power saving techniques in determining which location determination module 202 to invoke and/or when to invoke a location determination module 202 as discussed in more detail below.

A geo-fence event refers to the device entering the geo-fence, exiting the geo-fence, or staying in the geo-fence for a particular amount of time (e.g., being in the geo-fence and not exiting the geo-fence). The geo-fence event detection module 206 evaluates the uncertainty associated with the determined location relative to the size of the geo-fence in order to determine whether the computing device is inside the geo-fence or outside the geo-fence. The geo-fence event detection module 206 also tracks whether the computing device is inside or outside the geo-fence over time, and thus knows whether the computing device has moved from inside the geo-fence to outside the geo-fence, whether the computing device has moved outside the geo-fence to inside the geo-fence, an amount of time that the computing device has been inside the geo-fence, and so forth.

The geo-fence triggering module 208 analyzes the criteria to be satisfied in order for the geo-fence to be triggered, and determines whether the criteria are satisfied. This determination is made at least in part on the occurrence of one or more geo-fence events as determined by the geo-fence event detection module 206. In response to the criteria being satisfied, the module 208 determines that the geo-fence is triggered and takes the appropriate action. The action taken can be associated with geo-fence data for the triggered geo-fence stored in the data store 210, or can be determined in other manners such as being pre-configured in the geo-fence triggering module 208, being obtained from another module or device, and so forth.

In one or more embodiments, the action taken by the geo-fence triggering module 208 in response to the geo-fence being triggered is to notify one or more programs 230. The one or more programs 230 can include various different types of programs, such as applications, operating system modules or components, and so forth. The one or more programs 230 to be notified can be identified in different manners, such as being configured in the geo-fence triggering module 208, being identified as part of the geo-fence data for the geo-fence in the data store 210, being obtained from another module or service, and so forth. A program 230 can be notified of the geo-fence event that occurred, as well as optionally additional information (e.g., that the computing device was within a geo-fence for at least a threshold amount of time). The program 230 can then take the action it desires based on the geo-fence being triggered.

Although illustrated as modules separate from the location determination modules 202, it should be noted that one or more of the modules 204-208 can alternatively be implemented at least in part in one of the location determination modules 202. For example, at least part of one or more of the modules 204-208 can be implemented in hardware components of the GNSS module 214 or the Wi-Fi module 212.

In one more embodiments, a location is determined by the location determination modules 202 only after receiving user consent to do so. This user consent can be an opt-in consent, where the user takes an affirmative action to request that the location be determined by the location determination modules 202 before any such location is determined. Alternatively, this user consent can be an opt-out consent, where the user takes an affirmative action to request that the location not be determined by the location determination modules 202. If the user does not choose to opt out of determining the location, then it is an implied consent by the user to determine his or her location. Furthermore, it should be noted that the location determined by the location determination modules 202 can be maintained in a computing device receiving the determined location (e.g., the computing device 102 of FIG. 1) and need not be communicated to other devices or services.

Alternatively, user consent may be granted for specific programs and revoked for other programs. In this case, location information will be determined only when the user has consented for at least one program for which geo-fence tracking is used. The location information is used to determine the entry and/or exit of only those geo-fences belonging to the consented programs. Remaining geo-fences from the unapproved programs are not tracked.

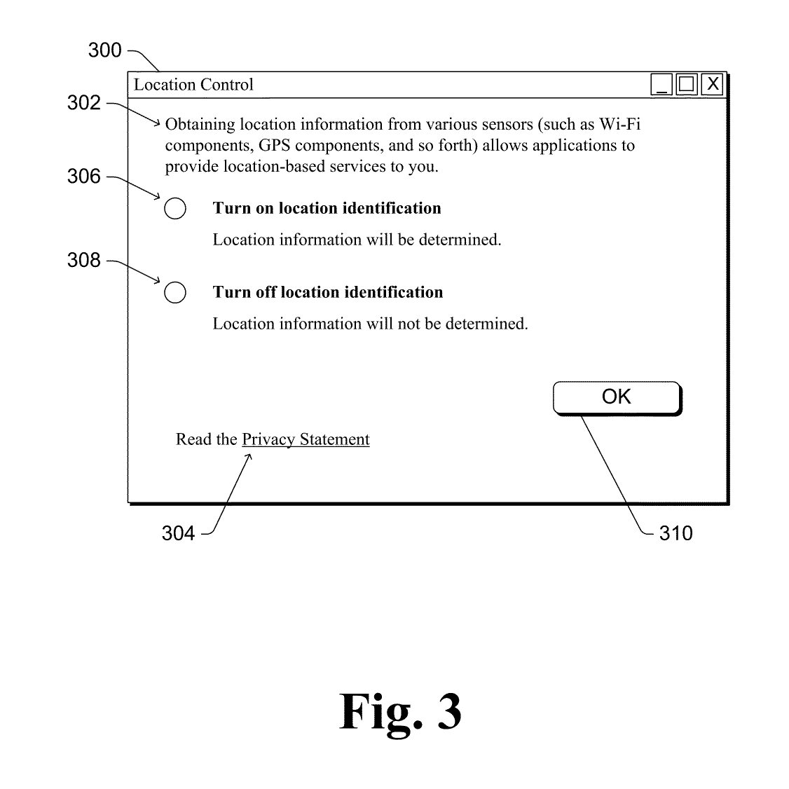

FIG. 3 illustrates an example user interface that can be displayed to a user to allow the user to select whether locations are to be determined in accordance with one or more embodiments. A location control window 300 is displayed including a description 302 explaining to the user why the location information is being determined. A link 304 to a privacy statement is also displayed. If the user selects the link 304, a privacy statement of the system 200 is displayed, explaining to the user how the user's information is kept confidential.

Additionally, the user is able to select a radio button 306 to opt-in to the determining of location information, or a radio button 308 to opt-out of the determining of location information. Once a radio button 306 or 308 is selected, the user can select an “OK” button 310 to have the selection saved. It is to be appreciated that radio buttons and an “OK” button are only examples of user interfaces that can be presented to a user to opt-in or opt-out of the determining of location information, and that a variety of other conventional user interface techniques can alternatively be used. The system 200 of FIG. 2 then proceeds to determine the location of the computing device, or not determine the location of the computing device, in accordance with the user's selection.

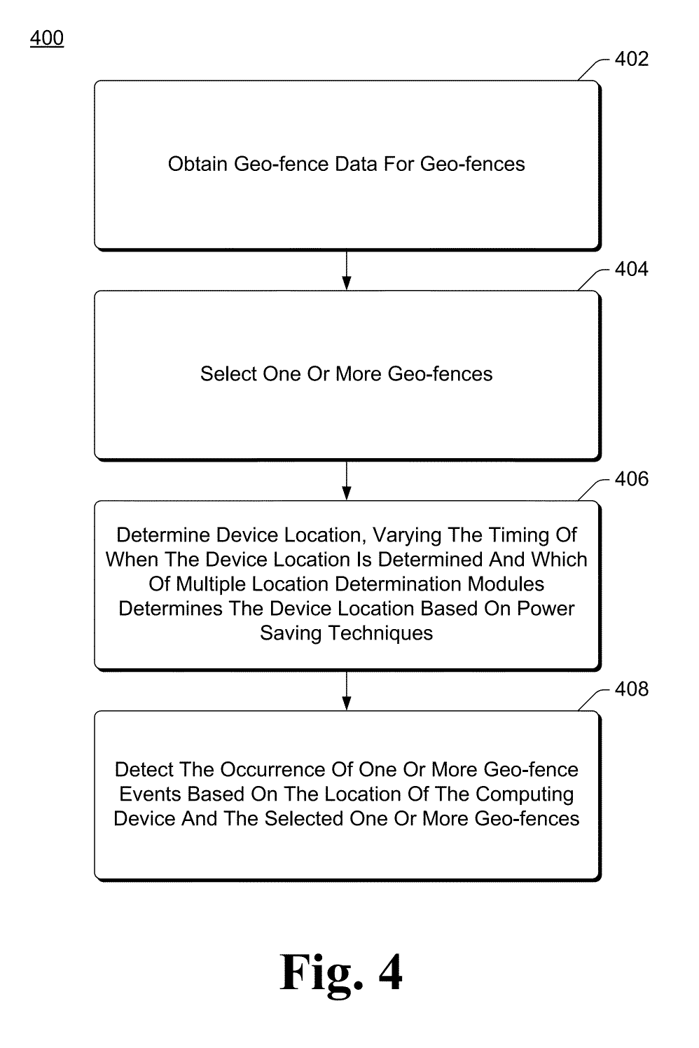

FIG. 4 is a flowchart illustrating an example process 400 for implementing reduced power location determinations for detecting geo-fences in accordance with one or more embodiments. The process 400 is carried out by a system, such as the system 200 of FIG. 2, and can be implemented in software, firmware, hardware, or combinations thereof. The process 400 is shown as a set of acts and is not limited to the order shown for performing the operations of the various acts. The process 400 is an example process for implementing reduced power location determinations for detecting geo-fences; additional discussions of implementing reduced power location determinations for detecting geo-fences are included herein with reference to different figures.

In process 400, geo-fence data for one or more geo-fences is obtained (act 402). The geo-fence data can be obtained from various sources as discussed above, such as programs installed or otherwise loaded on the device implementing the process 400.

One or more geo-fences are selected (act 404). The selected one or more geo-fences are one or more geo-fences selected by the geo-fence determination module 204 of FIG. 2 and can be selected in a variety of different manners as discussed above.

The location of the device is determined using one or more location determination modules (act 406). The timing of when the location of the device is determined and/or which of multiple location determination modules determines the location of the device varies based on various power saving techniques. These power saving techniques are discussed in additional detail below.

The occurrence of one or more geo-fence events based on the location of the computing device and the selected one or more geo-fences is detected (act 408). The location of the computing device is the location determined in act 406, and the selected one or more geo-fences are the geo-fences selected in act 404.

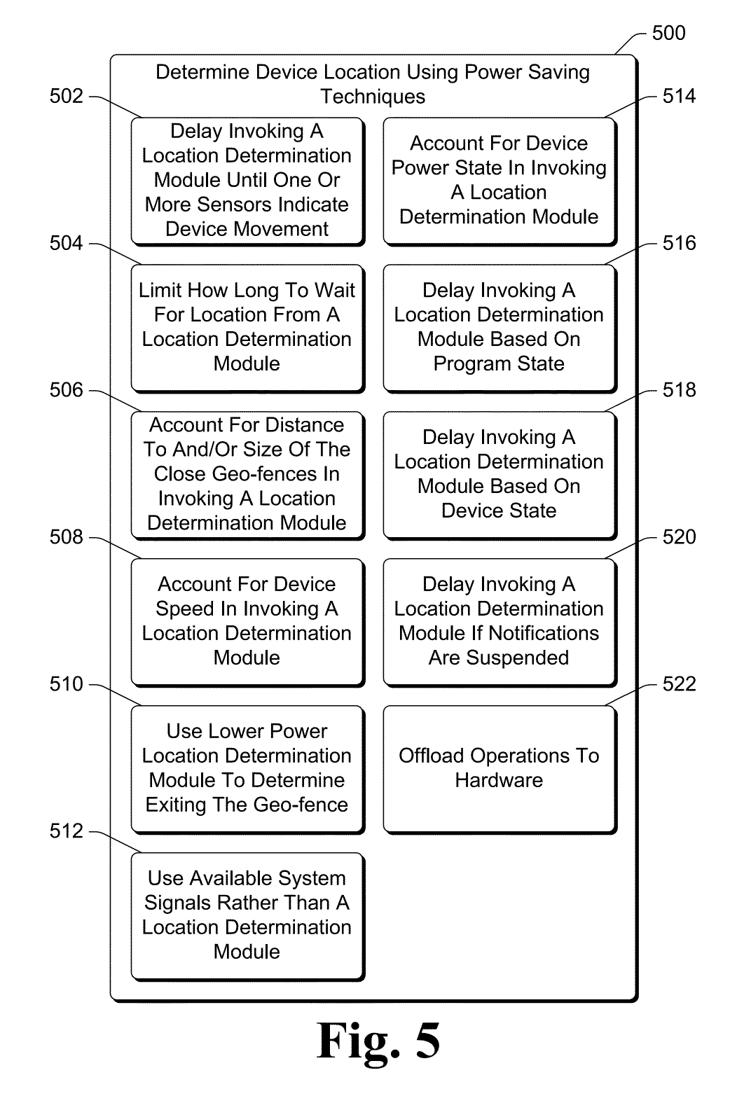

FIG. 5 illustrates an example implementation of determining 500 a location of the device while leveraging one or more of various power saving techniques in accordance with one or more embodiments. The determining 500 can be implemented by the power saving location checking module 220 of FIG. 2, and can be, for example, act 406 of FIG. 4. The determining 500 as illustrated in FIG. 5 includes multiple different acts 502-522. It should be noted that multiple individual acts of acts 502-522 can be implemented concurrently in any combination, or alternatively the acts 502-522 can be implemented individually. It should also be noted that not all of the acts 502-522 need be included in the determining 500. For example, the determining 500 may include a single one of the acts 502-522, or any combination of subsets of acts 502-522.

One power saving technique that can be included in the determining 500 is to delay invoking a location determination module until one or more sensors indicate movement of the computing device (act 502). Various different sensors can indicate movement of the computing device, such as an accelerometer, a gyroscope, a compass, a camera, beacon receivers (e.g., receiving notifications from Bluetooth transmitters, Bluetooth Low Energy (BLE) transmitters, radio frequency transmitters, Near Field Communication (NFC) transmitters, etc.), other receivers that receive connect and/or disconnect events from various beacons or other signal sources, a screen of a device (e.g., the screen being turn on indicating no movement is sensed and screen being off indicating movement is sensed), and so forth. The computing device includes a sensor or receives data from a sensor that experiences approximately the same movement as the computing device. For example, a sensor can be included in a computing device that implements the system 200 of FIG. 2, or in a device worn by the user that is also carrying the computing device that implements the system 200. The power saving location checking module 220 aggregates data from one or more sensors (e.g., from one or more axes of an accelerometer (e.g., three axes)), collecting data samples over a particular time period. If the sensor data indicates at least a threshold amount of movement (e.g., at least a particular distance) and/or a type of movement (e.g., walking or driving rather than standing or sitting) over the particular time period, then the computing device is determined to be moving and the power saving location checking module 220 invokes a location determination module to determine the location of the computing device. However, if the sensor data does not indicate at least the threshold amount of movement over the particular time period and/or the type of movement, then the computing device is determined to be not moving (e.g., stationary), and the power saving location checking module 220 invokes no location determination module (e.g., until the sensor data does indicate at least the threshold amount of movement and/or the type of movement).

Thus, by not invoking a location determination module if the sensor data indicates the computing device is not moving, the power for a location determination module to determine the location of the computing device need not be expended for a computing device that is not moving.

Another power saving technique that can be included in the determining 500 is to limit how long the power saving location checking module 220 waits for a location from a location determination module (act 504). Location determination modules can take various amounts of time to determine the location of the computing device depending on various circumstances such as interference with signals received, a quantity of signals being received, and so forth. The power saving location checking module 220 implements a timeout value (a threshold value) for a location determination module, such as a particular number of seconds. If the location determination module does not provide a location within the amount of time specified by the timeout value, then the power saving location checking module 220 provides an indication to the location determination module to cease attempting to determine the location of the computing device, and also invokes a different location determination module. The timeout value can be fixed, or alternatively vary. For example, the timeout value can be one value in situations where the computing device is operating in a plugged-in mode (e.g., using AC power rather than battery power), a smaller value in situations where the computing device is operating in a battery mode (e.g., on battery power), and an even smaller value in situations where the computing device is operating in a battery mode and the remaining battery life is less than a threshold amount.

The order in which the location determination modules are invoked can be determined in various manners. In one or more embodiments, the order is based on the desired accuracies of one or more geo-fences for which geo-fence events are being detected. The desired accuracy for a geo-fence refers to the accuracy (e.g., amount of uncertainty) that a location determination source is desired to have in order to determine geo-fence events for the geo-fence, and is based at least in part on the size of the geo-fence. The location determination modules can be invoked in order of various preferences, such as from cheap (e.g., lowest power consumption) to expensive (e.g., highest power consumption), starting with the cheapest location determination module having a desired accuracy to determine geo-fence events for the geo-fence.

Thus, by limiting how long the power saving location checking module 220 waits for a location from a location determination module, a location determination module experiencing difficulty in determining a location ceases attempting to determine the location and thus ceases expending power for the difficult task. A different location determination module can then attempt to determine the location of the computing device.

Another power saving technique that can be included in the determining 500 is to account for the distance to and/or a size of close geo-fences in invoking a location determination module (act 506). The close geo-fences refer to one or more of multiple geo-fences that are physically close to the computing device (e.g., all physically closest geo-fences or a subset of physically closest geo-fences), and are determined in accordance with various geo-fence tracking characteristics such as the distances to the physically closest fences and desired accuracies for the physically closest fences as discussed below. It should be noted that which geo-fences are the close geo-fences can change over time as the computing device moves, as new geo-fences are added, as geo-fences are removed, and so forth.

Geo-fence tracking parameters are discussed herein, and refer to a set of conditions determining the behavior for how geo-fences are tracked by the system 200, including timing indications of when checks are made as to whether geo-fence events occur, indications of location modules to invoke to determine a location of the computing device, and so forth. For example, this set of conditions can indicate an accuracy expected by the location determination module 202 providing the location of the computing device, a range or distance that the computing device can move before a check is to be made as to whether a geo-fence event has occurred, how frequently the system checks whether a geo-fence event has occurred, and so forth. The geo-fence tracking parameters may be determined based on the physically closest geo-fence, although need not be based on the physically closest geo-fence. The physically closest geo-fence refers to the geo-fence having a location on its edge (or alternatively other portion of the geo-fence, such as an approximate center of the geo-fence) that is geographically closest to the current determined location of the computing device (optionally without regard for the uncertainty in the determined location of the computing device).

The geo-fence tracking parameters are determined based on a desired accuracy for one or more geo-fences. The desired accuracy for a geo-fence refers to the accuracy (e.g., amount of uncertainty) that a location determination source is desired to have in order to determine geo-fence events for the geo-fence, and is based at least in part on the size of the geo-fence. Smaller geo-fences may need to have better desired accuracies (e.g., smaller amounts of uncertainty) and larger geo-fences may allow for worse desired accuracies (e.g., larger amounts of uncertainty). The desired accuracy for a geo-fence can be identified in a variety of different manners, such as a formula, table, rules or criteria, and so forth. In one or more embodiments, the system 200 is configured with or has access to a desired accuracy table that indicates the desired accuracy for different geo-fence sizes. The desired accuracy table can be populated with desired location accuracies for different geo-fence sizes in various manners, such as empirically by the designer of the system 200.

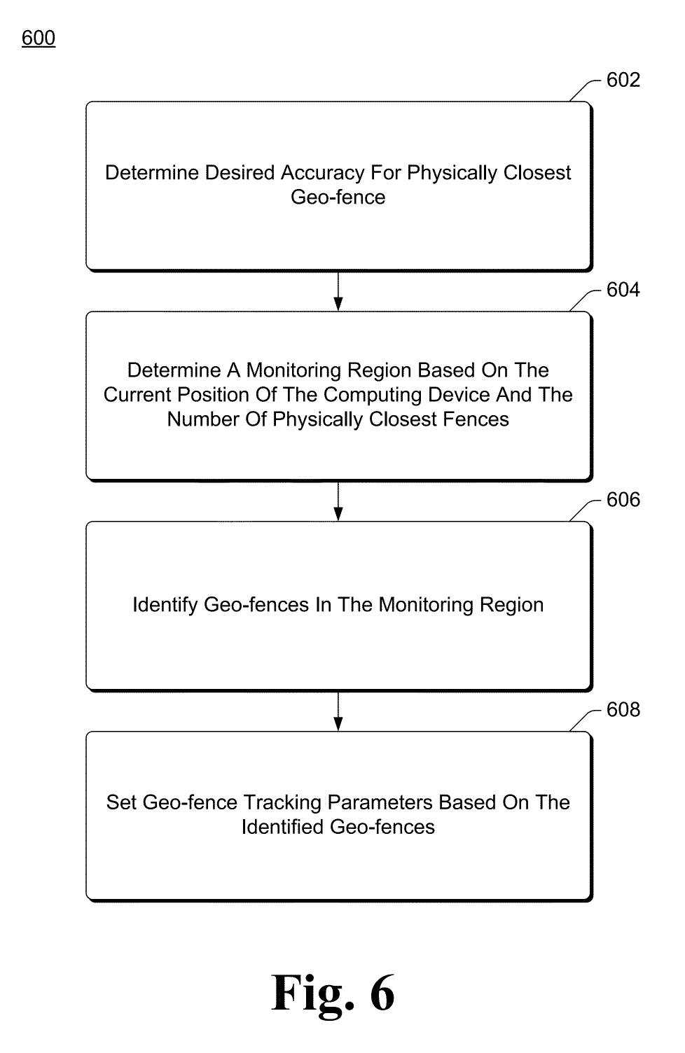

FIG. 6 illustrates an example process 600 for identifying the geo-fence tracking parameters in accordance with one or more embodiments. The process 600 is carried out by one or more modules, such as the power saving location checking module 220 of FIG. 2, and can be implemented in software, firmware, hardware, or combinations thereof. The process 600 is shown as a set of acts and is not limited to the order shown for performing the operations of the various acts. The process 600 is an example process for identifying geo-fence tracking parameters; additional discussions of identifying geo-fence tracking parameters are included herein with reference to different figures.

In process 600, a desired accuracy for the physically closest geo-fence is determined (act 602). The desired accuracy can be identified in various manners as discussed above. Alternatively, the desired accuracy in act 600 may be for an approximately physically closest geo-fence (e.g., the second closest or third closest geo-fence) rather than the closest geo-fence.

A monitoring region is determined based on the current position of the computing device and the number of physically closest fences (act 604). The monitoring region is a range from the computing device (e.g., a radius extending from the determined location of the computing device). This range can vary, such as being based on the distance to the physically closest geo-fence, a desired accuracy of the physically closest geo-fence, a number of other geo-fences within a threshold distance of at least a portion of the physically closest geo-fence, and so forth. The monitoring region refers to a region around the computing device implementing the system 200 that is searched for geo-fences in order to determine the current geo-fence tracking parameters. The current geo-fence tracking parameters can be determined using a formula that considers the distance to one or more physically closest geo-fences and the desired accuracies of those one or more physically closest geo-fences (e.g., by adding together the desired accuracy of the physically closest fences and the current distance to the physically closest fences). The desired accuracy can be expressed as a particular value (e.g., a particular number of meters from approximately the center of the physically closest geo-fence). The current distance to the physically closest fence refers to the distance between the currently determined location of the computing device (optionally without regard for the uncertainty in the determined location of the computing device) and a location on the edge (or alternatively other portion of the physically closest geo-fence, such as an approximate center of the physically closest geo-fence) of the geo-fence.

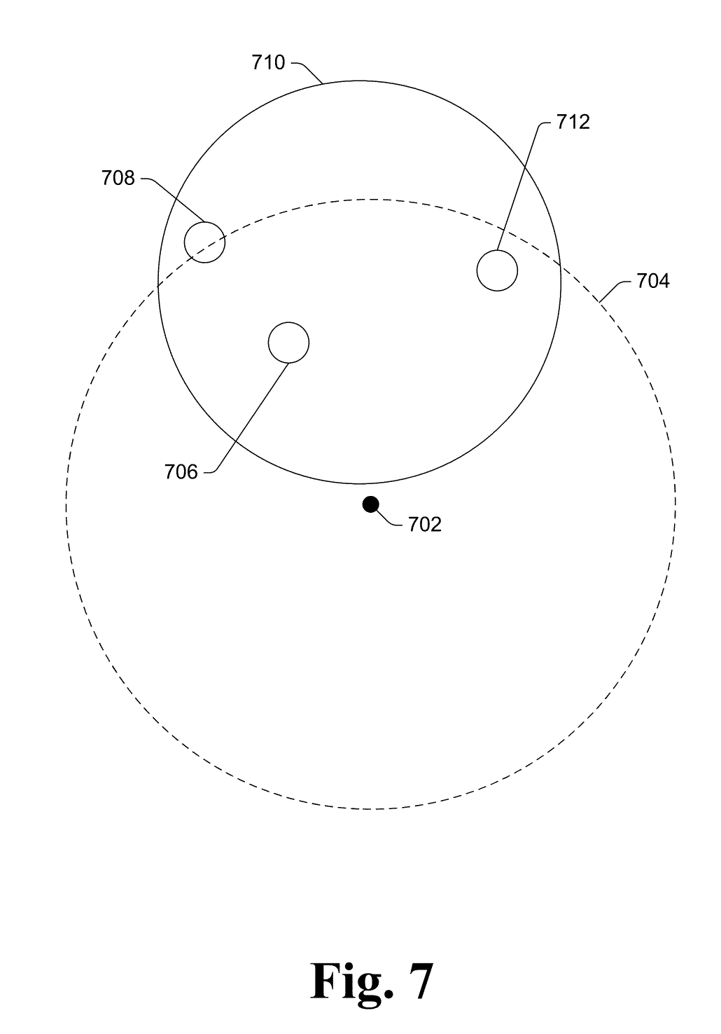

Geo-fences in the monitoring region are identified (act 606). A geo-fence is within the monitoring region if at least a portion of the geo-fence is within the monitoring region. In addition to the physically closest geo-fence, zero or more additional geo-fences can be identified as being in the monitoring region. FIG. 7 illustrates multiple overlapping geo-fences in accordance with one or more embodiments. A current location 702 of the computing device is illustrated, and a monitoring region 704 is determined. A set of geo-fences 706, 708, 710, and 712 are identified as being in the monitoring region.

Returning to FIG. 6, geo-fence tracking parameters are set based on the identified geo-fences (act 608). The identified geo-fences refer to the geo-fences identified in act 606. The tracking parameters can be set in a variety of different manners. For example, the most stringent (or approximately most stringent) desired accuracy of the desired accuracies of the identified geo-fences can be selected as the desired accuracy to use in determining which location determination module to invoke to determine the location of the computing device. Alternatively, the desired accuracies of the identified geo-fences can be combined in various manners, such as being averaged or added together (optionally weighting each geo-fence based on how close the geo-fence is to the current location of the computing device).

Returning to FIG. 5, the power saving location checking module 220 can invoke a location determination module to determine a location of the computing device at a lower frequency if the computing device is further from the close geo-fences than if the computing device is closer to them. For example, the power saving location checking module 220 may invoke a location determination module to determine a location of the computing device every five minutes if the computing device is one distance away from the close geo-fences (e.g., approximately 1 kilometer (km)), and every twenty minutes if the computing device is another distance away from the close geo-fences (e.g., approximately 50 km). The frequency can increase linearly or nonlinearly as the location of the computing device gets closer to the close geo-fences. The close geo-fences can be, for example, the geo-fences identified as being in the monitoring region in act 606 of FIG. 6.

Furthermore, given the distance to the close geo-fences, the power saving location checking module 220 may invoke a lower power location determination module that is less accurate than a higher power location determination module because the distance may indicate that the higher accuracy is not needed. The power saving location checking module 220 can invoke lower power but less accurate location determination modules if the computing device is further from the close geo-fences than if the computing device is closer to the close geo-fences (e.g., if the computing device is at least a threshold distance away from the close geo-fences). For example, a Wi-Fi location determination module may be lower power but less accurate than a GNSS location determination module. The power saving location checking module 220 may invoke the less accurate but lower power Wi-Fi location determination module to determine a location of the computing device if the computing device is a large distance away from the close geo-fences (e.g., approximately 50 km), and a more accurate but higher power GNSS location determination module if the computing device is a smaller distance away from the close geo-fences (e.g., approximately 500 m).

Thus, by reducing the frequency with which location determination modules are invoked when the computing device is further from the close geo-fences, the frequency with which the power for a location determination module is expended to determine the location of the computing device is reduced. Furthermore, by invoking a lower power location determination module when the computing device is further from the close geo-fences, the power for a higher power location determination module to determine the location of the computing device need not be expended.

Another power saving technique that can be included in determining 500 a location of the device is to account for the speed at which the computing device is moving to determine when to invoke a location determination module (act 508). As discussed above with reference to act 506, the frequency with which location determination modules are invoked when the computing device is further from the close geo-fences can be reduced. The frequency with which the power saving location checking module 220 invokes a location determination module can vary based on the speed at which the computing device is moving. For example, a location determination module can be invoked at a greater frequency if the computing device is moving quickly than if the computing device is moving slowly.

The speed at which the computing device is moving can be determined in a variety of different manners. For example, the speed can be obtained from another component or module of the computing device, such as a GPS component. By way of another example, the speed can be determined based on a history of recently determined locations. By way of yet another example, an indication of the speed can be received from another device (e.g., an automotive computer).

Given the speed of the computing device and the distance to the close geo-fences, an amount of time that the computing device will take to reach the close geo-fences at the current speed can be readily determined. This amount of time can be used to determine the frequency with which the power saving location checking module 220 invokes a location determination module. For example, if the amount of time is 90 minutes, then the power saving location checking module 220 may wait 80 minutes before invoking a location determination module.

The power saving location checking module 220 can also determine the frequency with which a location determination module is invoked based on the determined speed and how recently the speed was determined in order to account for changes in speed of the computing device. The frequency with which a location determination module is invoked can be increased as the speed of the computing device decreases (thus allowing for the possibility that the computing device speed will increase). For example, if the determined amount of time that it will take the computing device to reach the close geo-fences at the current speed is 90 minutes, then the power saving location checking module 220 may wait 40 minutes before invoking a location determination module in order to account for possible speed changes. By way of another example, if the determined amount of time that it will take the computing device to reach the close geo-fences at the current speed is 90 minutes and the speed is 500 miles per hour, then the power saving location checking module 220 may assume the computing device will not increase speed and wait 80 minutes before invoking a location determination module in order to account for possible speed changes. However, if the determined amount of time that it will take the computing device to reach the close geo-fences at the current speed is 90 minutes and the speed is 30 miles per hour, then the power saving location checking module 220 may assume the computing device may increase speed and thus wait 30 minutes before invoking a location determination module in order to account for possible speed changes.

Thus, by accounting for the speed at which the computing device is moving in invoking a location determination module, the frequency with which a location determination module is invoked (and thus the power expended by the location determination module in determining the location of the computing device) can be reduced.

Another power saving technique that can be included in the determining 500 is to use a lower power location determination module to detect exiting a geo-fence than to detect entering a geo-fence (act 510). In one or more embodiments, detecting exiting a geo-fence need not be as accurate as entering a geo-fence, so a lower power but less accurate location determination module can be used to detect a location of the computing device when the computing device is inside a geo-fence and exiting the geo-fence is being detected than if the computing device is outside the geo-fence and entering the geo-fence is being detected.

For example, a Wi-Fi location determination module may be lower power but less accurate than a GNSS location determination module. The power saving location checking module 220 may use the higher power GNSS location determination module when the computing device is outside the geo-fence and entering the geo-fence is being detected, and the lower power Wi-Fi location determination module when the computing device is inside a geo-fence and exiting the geo-fence is being detected.

Thus, by using a lower power location determination module when exiting a geo-fence, the power for a higher power location determination module to detect the location of the computing device need not be expended. Alternatively, situations can arise in which entering a geo-fence need not be as accurate as exiting a geo-fence, so a lower power but less accurate location determination module can be used to detect a location of the computing device when the computing device is outside a geo-fence and entering the geo-fence is being detected than if the computing device is inside the geo-fence and exiting the geo-fence is being detected

Another power saving technique that can be included in the determining 500 is to use available system signals rather than a location determination module (act 512). System signals refer to signals used by various modules or programs of the computing device other than for location determination. Various different signals can be used in the computing device, such as a wireless network or connection (e.g., Wi-Fi, BLE, NFC, etc.) connect or disconnect signal received from a transmitter (e.g., wireless access point, BLE transmitter, NFC transmitter, etc.) if the computing device moves a particular distance away from the transmitter, a serving cell transceiver change signal received from a cell transceiver if the computing device moves and is being service by a different cell transceiver, the strength of signals received from a transmitter or cell transceiver, and so forth.

These system signals can provide indications that the computing device has moved, and the power saving location checking module 220 can use these system signals in determining when to invoke a location determination module. The power saving location checking module 220 can delay invoking a location determination module based on one or more of these system signals. For example, if the range of a Wi-Fi access point is 200 m and the distance to the close geo-fences is more than 1000 m, then the power saving location checking module 220 can assume that as long as the computing device remains connected to the Wi-Fi access point the computing device is not entering another geo-fence. Accordingly, the power saving location checking module 220 can delay invoking a location determination module until a Wi-Fi disconnect signal is received from the wireless access point or the strength of signals received from the wireless access point changes (increases or decreases) by at least a threshold amount.

In one or more embodiments, the power saving location checking module 220 uses such system signals for stationary signal transmitters (e.g., wireless access points, cell transceivers, etc.). An indication of stationary (and/or non-stationary) signal transmitters can be obtained in a variety of different manners, such as being stored in the data store 210, being obtained from another device or service, and so forth. The power saving location checking module 220 does not rely on system signals from non-stationary signal transmitters because both the computing device and the signal transmitter may move, so no disconnect or change signal is received even though the computing device may have entered or exited geo-fence.

Thus, by leveraging available system signals, invoking a location determination module can be deferred and the power for a location determination module to determine the location of the computing device need not be expended.

Another power saving technique that can be included in the determining 500 is to account for a power state of the computing device in invoking a location determination module (act 514). The power saving location checking module 220 can vary which of the location determination modules is invoked to determine a location of the computing device and a frequency with which a location determination module is invoked to determine a location of the computing device. Various different rules or criteria can be used by the power saving location checking module 220 in determining which location determination module or modules to invoke and the frequency with which to invoke one or more location determination modules, such rules or criteria generally indicating that higher power location determination modules can be used when more power is available, and that location determination modules can be invoked more frequently when more power is available.

For example, a lower power location determination module can be used and/or location determination modules can be invoked less frequently if the computing device is operating in a battery mode (e.g., on battery power) than if the computing device is operating in a plugged-in mode (e.g., using AC power rather than battery power, or the battery is being charged). By way of another example, other power saving techniques discussed herein may be implemented with a variable range of frequencies with which location determination modules are invoked (e.g., timeout values for waiting for a location from a location determination module, frequency to invoke a location determination module based on distance to close geo-fences, etc.), and a frequency at the lower end of the range may be used if the computing device is operating in a battery mode with less than a threshold amount of battery power remaining than if the computing device is operating in a plugged-in mode or in a battery mode with a fully charged battery. By way of yet another example, a higher power location determination module (e.g., higher than may be indicated is to be used by other power saving techniques discussed herein) can be used and/or location determination modules can be checked more frequently (e.g., more frequently than may be indicated is to be used by other power saving techniques discussed herein) if the computing device is operating in a battery mode (e.g., on battery power) than if the computing device is operating in a plugged-in mode (e.g., using AC power rather than battery power, or the battery is being charged).

Thus, by using lower power location determination modules and/or invoking location determination modules less frequently when less power is available, the power for a higher power location determination module to determine a location of the computing device and/or more frequent location determinations need not be expended.

Another power saving technique that can be included in the determining 500 is to delay invoking a location determination module based on a program state (act 516). The program state refers to the state of one or more programs that can use the geo-fence events, such as programs registered with the system 200 of FIG. 2, programs identified in geo-fence data in the data store 210, and so forth. The program state refers to various different information regarding the program, such as whether the program is running in the foreground or not actively running at all. For certain program states, the power saving location checking module 220 can assume that location determinations can be made less frequently and thus delay invoking a location determination module. For example, if the program being notified of geo-fence events is suspended, then the power saving location checking module 220 can assume that the program is not being actively used by a user of the computing device, and thus that location determinations can be made less frequently and invoking a location determination module can be delayed. The invoking of a location determination module can be delayed for a particular amount of time (e.g., a particular number of minutes), until a particular event occurs (e.g., the program state changes), and so forth.

Thus, by invoking a location determination module less frequently for certain program states, the power for location determination modules to determine the location of the computing device need not be expended as frequently (e.g., such as when a program is not being actively used by a user of the computing device).

Another power saving technique that can be included in the determining 500 is to delay invoking a location determination module based on a state of the computing device (act 518). The computing device state refers to various information regarding how the computing device is being used, such as whether a display of the computing device is turned on or off, whether a speaker of a computing device is turned on or off, whether a user is looking at the computing device, and so forth. For certain computing device states, the power saving location checking module 220 can assume that location determinations can be made less frequently and thus delay invoking a location determination module. For example, if the display of the computing device is turned off, then the power saving location checking module 220 can assume that the computing device is not being actively used, and thus that location determinations can be made less frequently and invoking a location determination module can be delayed. The invoking of a location determination module can be delayed for a particular amount of time (e.g., a particular number of minutes), until a particular event occurs (e.g., the computing device state changes), and so forth.

Thus, by invoking a location determination module less frequently for certain computing device states, the power for location determination modules to determine the location of the computing device need not be expended as frequently.

Another power saving technique that can be included in the determining 500 is to delay invoking a location determination module if notifications for the computing device are suspended (act 520). Notifications for a computing device can be suspended in various manners, such as by a user, by another module or device, and so forth. When notifications for a computing device are suspended, notifications (e.g., audible, visual, haptic, etc.) of particular events in the system 200 that would otherwise be provided to a user by a program of the computing device are not provided to the user. The power saving location checking module 220 can assume that the user does not want to be interrupted by the computing device if notifications are suspended, and thus location determinations can be made less frequently and invoking a location determination module can be delayed. The invoking of a location determination module can be delayed for a particular amount of time (e.g., a particular number of minutes), until a particular event occurs (e.g., notifications are no longer suspended), and so forth.

Thus, by invoking a location determination module less frequently when notifications for a computing device are suspended, the power for location determination modules to determine the location of the computing device need not be expended as frequently.

Another power saving technique that can be included in the determining 500 is to offload operations to hardware or a dedicated low power chipset (act 522). In one or more embodiments, parts of the system 200 can be implemented in hardware or a dedicated low power chipset. In some situations, various determinations can be made consuming less power when implemented in hardware than when implemented in software or firmware. In such situations, the power saving location checking module 220 can provide an indication to one or more hardware components or a dedicated low power chipsets of determinations to be made by hardware components or chipsets. For example, the power saving location checking module 220 can provide an indication to a GNSS module to determine a location of the computing device at a particular frequency or after a particular amount of time elapses, and return to the power saving location checking module 220 indications of the determined one or more locations.

Thus, by having some operations performed in hardware or a dedicated low power chipset, the power consumed in having a location determination module determine the location of the computing device is reduced.

Although particular functionality is discussed herein with reference to particular modules, it should be noted that the functionality of individual modules discussed herein can be separated into multiple modules, and/or at least some functionality of multiple modules can be combined into a single module. Furthermore, it should be noted that a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

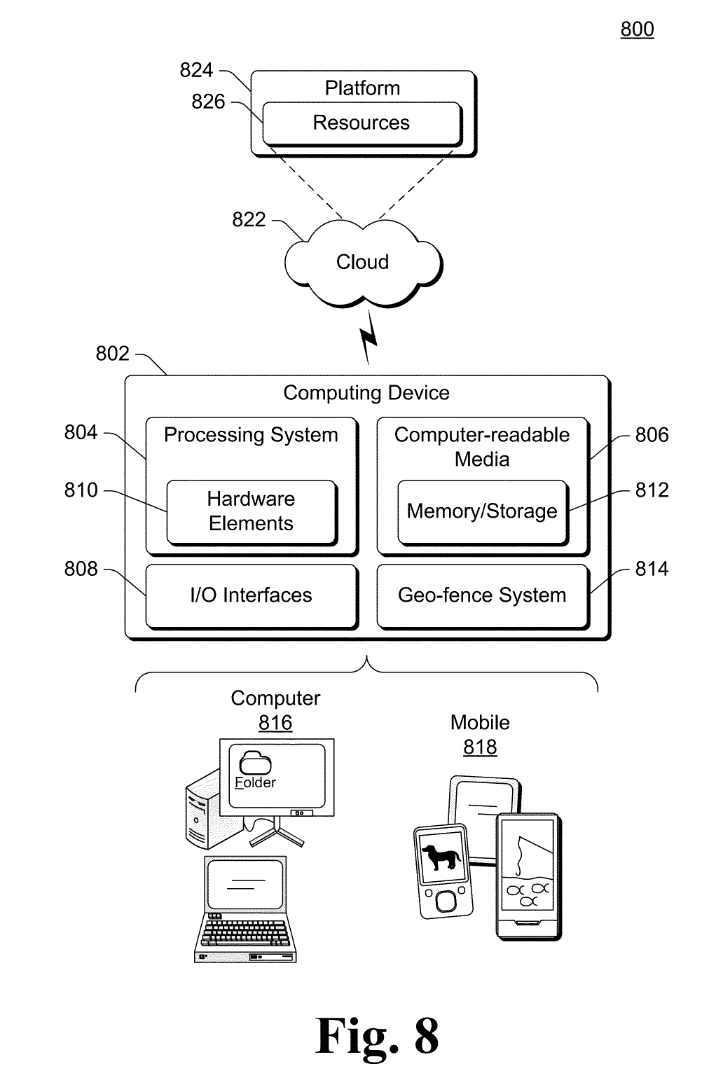

FIG. 8 illustrates an example system generally at 800 that includes an example computing device 802 that is representative of one or more systems and/or devices that may implement the various techniques described herein. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

Computing device 802 also includes a geo-fence system 814. Geo-fence system 814 provides various geo-fence functionality, including reduced power location determinations for detecting geo-fences, as discussed herein. Geo-fence system 814 can implement, for example, the system 200 of FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules as a module that is executable by the computing device 802 as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a mobile device, and/or other devices. Services and applications run substantially similar in these environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 802 may assume a variety of different configurations, such as for computer 816 or mobile 818 uses. Each of these configurations includes devices that may have generally different constructs and capabilities, and thus the computing device 802 may be configured according to one or more of the different device classes. For instance, the computing device 802 may be implemented as the computer 816 class of a device that includes a personal computer, desktop computer, a multi-screen computer, laptop computer, netbook, and so on. The computing device 802 may also be implemented as the mobile 818 class of device that includes mobile devices, such as a mobile phone, portable music player, portable gaming device, a tablet computer, a wearable computer, a multi-screen computer, and so on.

The techniques described herein may be supported by these various configurations of the computing device 802 and are not limited to the specific examples of the techniques described herein. This functionality may also be implemented all or in part through use of a distributed system, such as over a “cloud” 822 via a platform 824 as described below.

The cloud 822 includes and/or is representative of a platform 824 for resources 826. The platform 824 abstracts underlying functionality of hardware (e.g., servers) and software resources of the cloud 822. The resources 826 may include applications and/or data that can be utilized while computer processing is executed on servers that are remote from the computing device 802. Resources 826 can also include services provided over the Internet and/or through a subscriber network, such as a cellular or Wi-Fi network.

The platform 824 may abstract resources and functions to connect the computing device 802 with other computing devices. The platform 824 may also serve to abstract scaling of resources to provide a corresponding level of scale to encountered demand for the resources 826 that are implemented via the platform 824. Accordingly, in an interconnected device embodiment, implementation of functionality described herein may be distributed throughout the system 800. For example, the functionality may be implemented in part on the computing device 802 as well as via the platform 824 that abstracts the functionality of the cloud 822.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
selecting a set of one or more geo-fences, the selecting being based at least in part both on desired accuracies to use in detecting geo-fence events for the set of one or more geo-fences and on a distance from a computing device to at least one of the set of one or more geo-fences; and
determining, based on one or more power saving techniques, both which of multiple location determination modules to use to determine a location of the computing device and how often to have one or more of the multiple location determination modules determine the location of the computing device.

2. A method as recited in claim 1, further comprising detecting occurrence of one or more geo-fence events based on the location of the computing device and the selected geo-fence.

3. A method as recited in claim 1, the determining comprising:
delaying having one of the multiple location determination modules determine the location of the computing device until a sensor indicates movement of the computing device.

4. A method as recited in claim 1, the determining comprising:
invoking a first location determination module of the multiple location determination modules, the first location determination module having a desired accuracy to determine geo-fence events; and
invoking a second location determination module of the multiple location determination modules in response to a location not being determined by the first location determination module within a threshold amount of time.

5. A method as recited in claim 1, further comprising determining geo-fence tracking parameters by:
determining a desired accuracy for the closest geo-fences; and
determining additional geo-fence tracking parameters based on the desired accuracy for the closest geo-fences and a current distance from the computing device to the closest geo-fences.

6. A method as recited in claim 1, the determining how often to have one or more of the multiple location determination modules determine the location of the computing device being based on a speed at which the computing device is moving.

7. A method as recited in claim 1, the determining which of multiple location determination modules to use to determine the location of the computing device using a lower power location determination module to detect exiting one of the set of multiple geo-fences than to detect entering one of the set of multiple geo-fences.

8. A method as recited in claim 1, the determining comprising:
delaying having one of the multiple location determination modules determine the location of the computing device until a connect or disconnect signal is received from a transmitter.

9. A method as recited in claim 1, the determining comprising:
delaying having one of the multiple location determination modules determine the location of the computing device until a serving cell transceiver change signal is received from a cell transceiver.

10. A method as recited in claim 1, the determining comprising:
accounting for a power state of the computing device in determining both which of multiple location determination modules to use to determine a location of the computing device and how often to have one or more of the multiple location determination modules determine the location of the computing device.

11. A method as recited in claim 1, further comprising:
reducing a frequency at which the location of the computing device is determined based on a program state of a program being notified of geo-fence events.

12. A method as recited in claim 1, the determining comprising:
delaying having one of the multiple location determination modules determine the location of the computing device based on a state of the computing device.

13. A method as recited in claim 1, further comprising:
reducing a frequency at which the location of the computing device is determined in response to notifications for the computing device being suspended.

14. A method as recited in claim 1, further comprising performing at least some of the selecting and the determining in hardware or a dedicated low power chipset.

15. A computing device comprising:
a data store to store geo-fence data for multiple geo-fences;
one or more location determination modules implemented at least in part in hardware each configured to provide a location of the computing device; and
a power saving location checking module to invoke, based at least in part on sizes of one or more of the multiple geo-fences and a closest one of the multiple geo-fences, one or more of multiple location determination modules.

16. A computing device as recited in claim 15, the power saving location checking module being configured to invoke a first location determination module of the multiple location determination modules, and invoke a second location determination module of the multiple location determination modules in response to a location not being determined by the first location determination module within a timeout value.

17. A computing device as recited in claim 15, the power saving location checking module being configured to use a module with lower power use from the multiple location determination modules to detect exiting than to detect entering of a geo-fence.

18. A computing device as recited in claim 15, the power saving location checking module being configured to delay having one of the multiple location determination modules determine the location of the computing device until a connect or disconnect signal is received from a transmitter.

19. A computing device as recited in claim 15, the power saving location checking module being configured to delay having one of the multiple location determination modules determine the location of the computing device until a serving cell transceiver change signal is received from a cell transceiver.

20. A computing device comprising:
a data store to store geo-fence data for multiple geo-fences;
one or more location determination modules implemented at least in part in hardware each configured to provide a location of the computing device; and
a power saving location checking module to determine both which of multiple location determination modules to use to determine a location of the computing device and how often to have one or more of the multiple location determination modules determine the location of the computing device by delaying having the multiple location determination modules determine the location of the computing device based on a program state of a program being notified of geo-fence events, delaying having the multiple location determination modules determine the location of the computing device based on a state of the computing device, and delaying having the multiple location determination modules determine the location of the computing device in response to notifications for the computing device being suspended.
